(19) United States
(12) Patent Application Publication
(10) Pub. No.: US 2007/0261452 A1
(43) Pub. Date: Nov. 15, 2007

(54) Aeration or air floors and methods for constructing and using such floors

(76) Inventor: Charles S. Harbert, Redmond, WA (US)

Correspondence Address: PERKINS COIE LLP;PATENT-SEA, P.O. BOX 1247, SEATTLE, WA, 98111-1247, US

(21) Appl. No.: 11/650,331

(22) Filed: Jan. 5, 2007

Related U.S. Application Data
(60) Provisional application No. 60/756,211, filed on Jan. 5, 2006.

(51) Int. Cl. C05F 17/00; B08B 3/00; E04F 15/08

(52) U.S. Cl. 71/11; 134/42; 52/302.1

(57) ABSTRACT

Aeration or air floors for composting, agricultural product storage, or other suitable uses are disclosed herein. In one embodiment, an aeration floor system includes a hollow core slab having a surface and a hollow tube extending in a direction generally parallel to the surface. The system further includes a slot extending between the surface and the hollowed tube. The slot has a tapered cross-sectional shape.

### CROSS-REFERENCE TO RELATED APPLICATION

This application claims the benefit of U.S. Provisional Patent Application No. 60/756,211, filed Jan. 5, 2006, which is incorporated by reference herein.

### TECHNICAL FIELD

Aeration or air floors for composting, agricultural product storage, or other suitable uses are disclosed herein.

### BACKGROUND

Composting is a natural biological process which transforms waste organic materials, such as food refuse, municipal solid waste, biosolids sludge, manure, etc. into a non-hazardous fertilizer called compost. For efficient processing into compost, the proper mixture of organic material must be brought to the right moisture level (e.g., 40-60%) and then air (e.g., oxygen) must be evenly circulated through the compost pile. Turning or agitation of the compost pile is normally required to expose all areas to air to promote microbial action. Various methods of composting have been used for thousands of years, but with the recent need for large scale composting, various floor systems have been developed to introduce air into the compost pile. Curing of compost is done after initial composting has been completed to finish the process.

One method for large scale composting is to place perforated pipes on a concrete floor and then to spread a layer of gravel over the pipes onto which is placed the material to be composted. This type of floor works well until it plugs from fine material building up in the gravel bed. This type of floor must be periodically dismantled to be cleaned. Moreover, the size of mobile equipment on the gravel over the pipes must be restricted to avoid pipe breakage. Another conventional aeration floor type has utilized pre-molded interlocking plastic grates which use a pattern of slots in the top surface connecting to an air plenum below. This type of aeration floors can be damaged by large mobile equipment running on top and high compost pile temperature which can weaken the plastic structure.

Another one of the current methods of composting for large scale processing includes a concrete or asphalt floor overlaying metal or plastic pipes with spigots protruding out from the pipe to floor level at regular intervals. Air is then blown (positive aeration) or pulled (negative aeration) through the pipe and spigot holes into the compost pile. Composting floors need to be designed such that large mobile equipment, such as front end loaders, can operate on top of the floor to load and unload the pile.

Historically, during composting, normal air flow has been under positive pressure through the pipes or plenum, but recently there has been some success reversing the air flow to pull (negative aeration) the air through the compost pile into the pipe or plenum to reduce harmful emissions, as well as to hold heat in the compost pile. Plugging has been a large problem for negative aeration systems.

The plugging usually occurs during the initial phases of composting when the compost pile has a high moisture content which tends to carry a mixture of fine wet material into the floor openings where it dries out due to airflow and thus, plugs the openings. Plugging can also occur during loading and unloading of the compost material onto the floor by way of smearing of compost material into the air flow openings, generally caused by mobile equipment maneuvering on the floor. Plugging or clogging of the air flow openings causes increase fan pressures which increases power usage, or may even necessitate unloading of the compost pile to clear the air flow openings.

One of the other problems of many conventional systems is non-uniform air flow through the compost pile due to the wide spacing of the air flow openings. Uniform airflow assists in keeping the digesting microbes supplied with adequate oxygen. Composting is best done in an aerobic (with adequate oxygen) condition, rather than under an anaerobic (without adequate oxygen) condition. Anaerobic digestion produces noxious odors, such as ammonia and hydrogen sulfide (rotten egg) odors, as well as a degraded compost.

Several conventional composting floors can be difficult and expensive to build because they must be field fabricated with pipes and other attachments which are held in place by poured concrete (or asphalt) including some kind of reinforcement to secure the pipe and strengthen the concrete.

Another factor for designing a composting floor is the liquid (leachate) that flows out of the moist compost pile during the composting process. This liquid contains harmful and corrosive chemicals that should be contained and treated before discharge. It can be recycled and then used to moisten a biofilter pile.

Biofilters are similar to composting in that a mixture of organic and non-organic material is piled up on a positive aeration floor for the purpose of processing odors and corrosive gases, primarily coming from a composting operation. The biofilter media is only changed every one to two years, thus reducing the need for floor strength for regular mobile equipment usage. Floor construction is similar to the composting aeration floors mentioned above using perforated pipe and spigot systems, or plastic perforated plates.

Many perishable agricultural products, such as potatoes and onions, can be preserved for a much longer storage life if they can be cooled rapidly after harvesting and then kept at low temperatures. In addition to cooling, a high humidity environment prevents moisture loss from inside the product to the outside atmosphere. As with composting, many perishable products produce natural heat when in a pile, which must be rapidly and uniformly removed to prevent the product from deteriorating. Aeration floors are common in this industry, but are characterized by poor air distribution and non-durable floors.

### SUMMARY

Several embodiments of this invention are directed to aeration or air floors for composting, agricultural product storage, or other suitable uses. The aeration floors can include a prefabricated hollow core concrete slab with a plurality of slots extending from a surface to one of the hollow core tubes. The slots may have a tapered configuration (e.g., an inverted “V”, or an inverted “U”). Hollow core slabs (or planks) are a common construction product readily available throughout the world. They are generally made in 4 to 8 foot widths, 4 to 18 inches in height, and up to 40-60 feet in length. The hollow core holes can extend horizontally through the entire length of the slab, and are generally round or oval in shape. The core holes can comprise 40-50% of the total cross sectional area of the slab. The hollow core slabs may be manufactured with indentations on the outer sides so that when laid side by side they can be interlocked using a cement grout.

The prefabricated hollow core slabs can be slotted during initial manufacturing, or afterwards at the job site with concrete sawing equipment or other suitable devices. In several embodiments, the slots can be narrow (e.g., less than 1 inch wide) at a surface of the slab and then taper outward to inhibit material from adhering at the opening of the slots. This is expected to reduce or eliminate plugging. In one application, all the slots run longitudinally along the slab into all, or part, of the hollow core tubes. The slots can be continuous or non-continuous, depending on design strengths required. In one embodiment, the slots are spaced uniformly apart (e.g., generally less than 12 inches apart) and provide a fine mesh air distribution system for either pulling air through the pile material (negative aeration) or for blowing air through the pile material (positive aeration). This is expected to provide generally uniform air flow and temperature distribution for composting or storing agricultural products.

In one embodiment, operating the composting floor under negative aeration reduces the emission of corrosive vapors because they are being pulled into the core thereby preventing an attack to the building components when operating in an enclosed space. When operating outdoors under negative aeration mode, there is a reduction of polluting gases because they are pulled through the pile into the aeration floor for delivery to the biofilter.

One feature of several embodiments of the aeration floor is that the floor can withstand the load of very large mobile equipment because it is manufactured of very high strength concrete (e.g., greater than 6,000 psi) containing prestressed reinforced steel cables. The slabs can also be designed to span long distances with only end supports which reduces ground preparation requirements to only the ends, thus reducing installation cost. Installation of the precut slabs onto the ground is easily and inexpensively done with mobile equipment, such as lift trucks or cranes. This high strength concrete is also better able to withstand corrosion attack from compost gases and liquids. Moreover, in several embodiments, the aeration floor collects liquids flowing from the moist compost pile which drain through the slot into the core for safe collection and handling without leaking into the ground below and causing contamination.

In several embodiments, a high pressure water system may be coupled to the aeration floor for rapid cleaning and aeration/agitation of the compost pile. For example, the system can use over 1,000 psi water flowing rapidly (after the valve opening) through precision calibrated vertical nozzles facing upward to blow out the slot, as well as to force any material in the horizontal core into a collector sump.

This system can use very high water pressure supplied from a low volume, high pressure pump in conjunction with an air/water accumulator to provide a significant kinetic energy water pulse into the empty pressure pipe when the solenoid is opened. The accelerating water pulse (water hammer) slams through the nozzles in the pipe at high speed to blast the compost material. The accumulator maintains the flow when the pump is overwhelmed by the flow rate, thereby reducing the pump size. This system can also be used for other composting or aeration floors with similar needs.

The use of the high pressure water cleaning system can also be used at any time in the process to open the slots, thereby restoring full air flow. The underfloor core hole of the hollow core slab also can be easily cleaned, with or without the high pressure cleaning system installed, which can be a problem for many other systems because of limited access to the underfloor pipe or plenum. For example, a portable high pressure (e.g., a pressure washer) water spray system can easily clean the horizontal core from above, by spraying through the slot. Unlike other conventional floors, several embodiments of the aeration floor need not be dismantled to be cleaned.

During composting, the high pressure water system can also be positioned to bore additional aeration holes into the compost pile above, as well as agitate the pile, which re-channels the air flow through the pile. This reduces or eliminates the need to turn or agitate the pile which is common for most other systems, thereby reducing operating costs.

### BRIEF DESCRIPTION OF THE DRAWINGS

FIG. 1A is a perspective and FIG. 1B is an end view of a hollow core slab in accordance with one embodiment of the disclosure.

FIG. 2A is a perspective and FIG. 2B is an end view of a slotted hollow core slab with a plurality of inverted “V” shaped slots extending between the top of the slab and the hollow core/tube in accordance with one embodiment of the invention.

FIG. 3A is a plan view and FIG. 3B is a side elevation of a length of hollow core slab with non-continuous and continuous slots in accordance with another embodiment of the invention.

FIG. 4 is a plan view showing a schematic layout of a composting system including the composting, curing, and biofilter aeration floors with non-continuous slots in accordance with one embodiment of the invention.

FIG. 5A is a partial perspective view of a slotted hollow core showing a high pressure water pipe with upward facing nozzles installed below the inverted “V” slot including a longitudinal core/tube cleaning pipe and nozzle in accordance with another embodiment of the invention.

FIG. 5B is an end view of a slotted hollow core slab showing the high pressure water pipe of FIG. 5A.

FIG. 5C is a side elevation view of a slotted hollow core slab showing the high pressure water pipe of FIG. 5A.

FIG. 6A is a partial perspective view of the collector sump with a slotted hollow core slab connected to one side, and the discharge air pipe and liquid leachate pipe connected to the opposite side in accordance with one embodiment of the invention.

FIG. 6B is a side elevation view of the collector sump of FIG. 6A.

### DETAILED DESCRIPTION

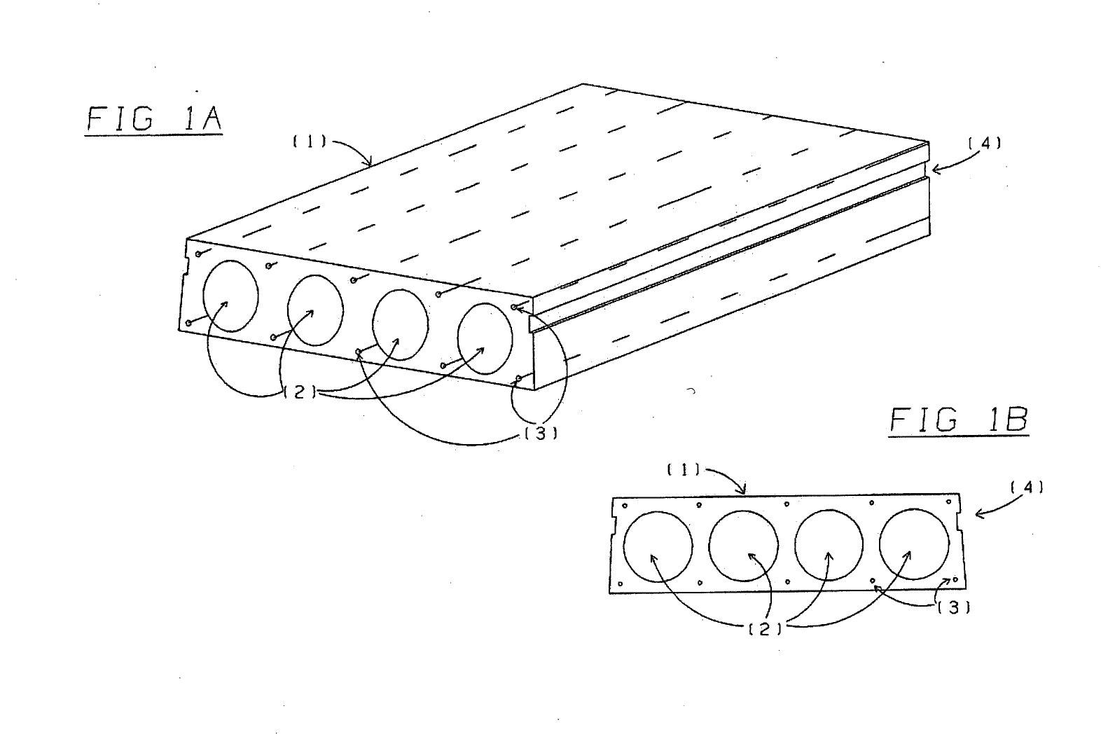

Specific details of several embodiments of the invention are described below with reference to aeration or air floors for composting, agricultural product storage, or other suitable uses. Several details describing well-known structures or processes often associated with air floors, composting and agricultural product storage are not set forth in the following description for purposes of brevity and clarity. Also, several other embodiments of the invention can have different configurations, components, or procedures than those described in this section. A person of ordinary skill in the art, therefore, will accordingly understand that the invention may have other embodiments with additional elements, or the invention may have other embodiments without several of the elements shown and described below with reference to FIGS. 1A-6B.

Where the context permits, singular or plural terms may also include the plural or singular term, respectively. Moreover, unless the word “or” is expressly limited to mean only a single item exclusive from other items in reference to a list of at least two items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same features and/or other types of features and components are not precluded.

FIGS. 1A and 1B schematically illustrate a precast concrete hollow core slab (1) (aka hollow core plank) that is readily available from commercial manufacturers throughout the United States, including most other countries in the world. The slab (1) can be manufactured with various widths (e.g., 4 ft. to 8 ft.), various thicknesses (e.g., 4 inches to 18 inches), and various lengths (e.g., up to 60 ft). The illustrated slab (1) includes a plurality of hollow core/tubes (2) that extend between two opposite ends of the slab (1). The hollow tubes (2) can have a variety of cross-sectional shapes (e.g., generally round or oblong holes). The most common methods of manufacturing are “extrusion” or “slip-casting” both of which use a forming machine moving along a casting bed leaving a finished hollow core slab behind the forming machine.

The illustrated hollow core slab (1) also contains pretensioned steel cables (3) in the bottom cord, and sometimes in the top chord, which gives it large compressive and tensile strength enabling the slab to be supported only at its ends. As such, large rubber-tired mobile equipment or other devices can operate on the slab (1). The concrete used in making hollow core slabs can have a high strength, (e.g., greater than 6,000 psi), plus be corrosion resistive. Hollow core slabs are generally manufactured using 2 basic methods, extrusion and slip forming. An locking notch (4) is formed in the side of the slab for interlocking side by side slabs.

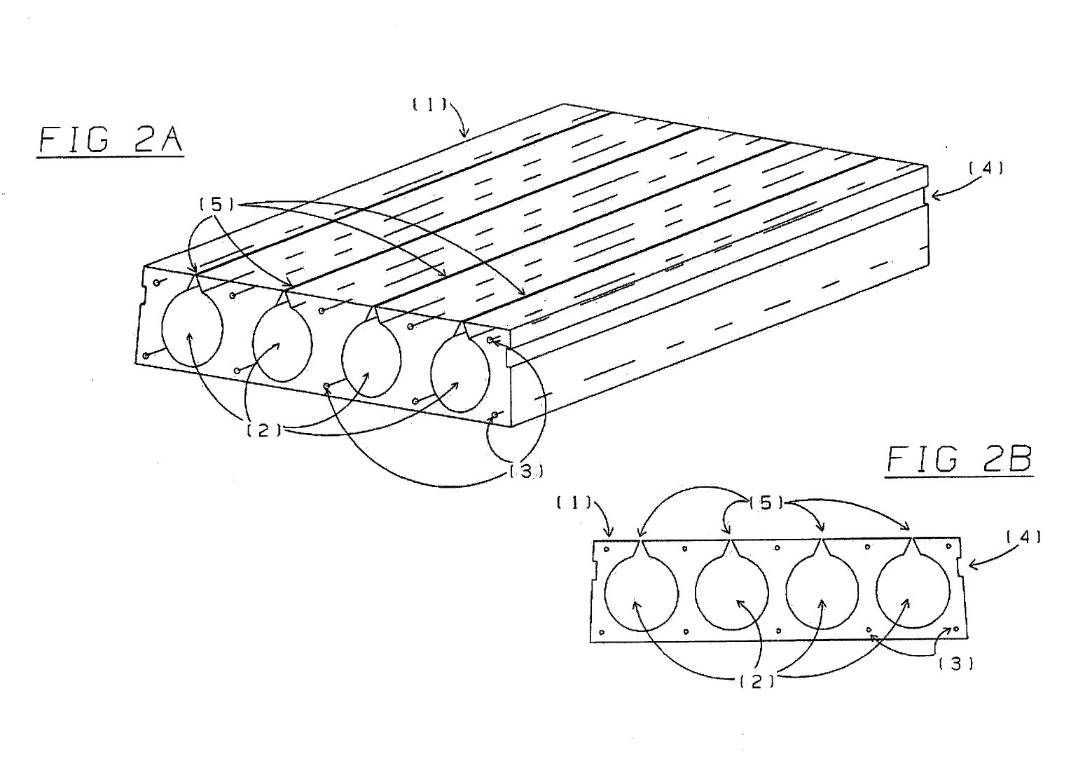

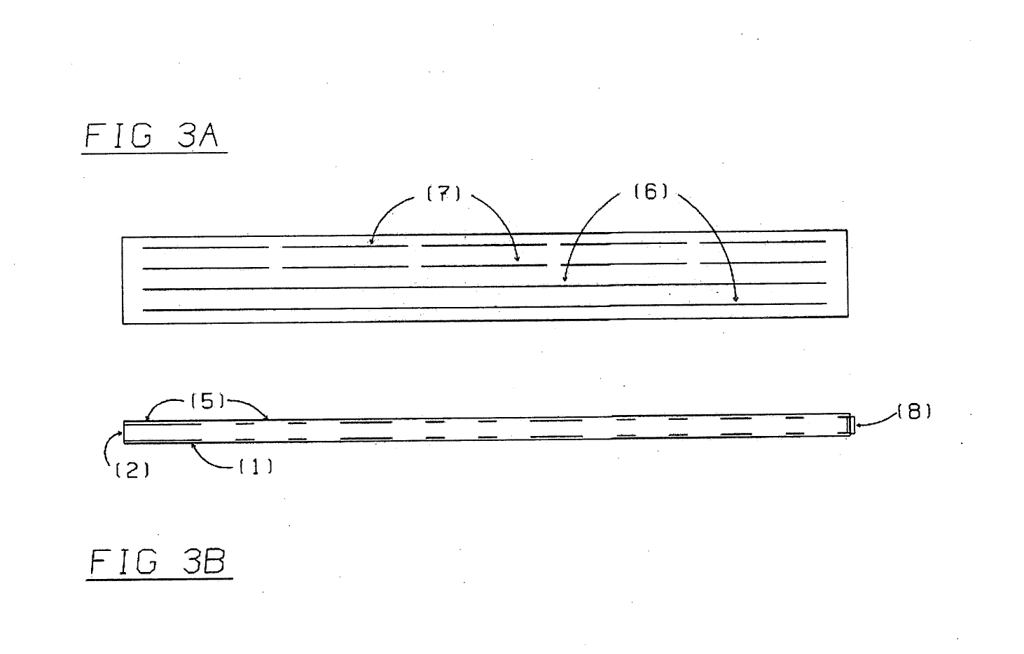

FIGS. 2A and 2B illustrate a hollow core aeration floor section after forming a plurality of continuous slots (5) extending between the top surface of the hollow core slab (1) and corresponding hollow core/tubes (2). Although in the illustrated embodiment, the slots (5) extend along the entire length of the hollow core slab (1), in other embodiments, the slots may be discontinuous or not extend along the entire length of the slab (1). For example, FIGS. 3A and 3B illustrate a hollow core aeration floor section with a plurality of continuous slots (6) and a plurality of discontinuous slots (7). The discontinuous slots (7) include a plurality of sections that are spaced apart longitudinally by a distance.

Referring back to FIGS. 2A and 2B, the illustrated slots (5) have a tapered configuration with an inverted “V” shape. As such, the slots (5) have a first width at the top surface of the slab and a second width greater than the first width at the hollow cores/tubes (2). The inverted “V” shape of the illustrated slots (5) is expected to be less susceptible to plugging. In other embodiments, however, the slots can have other cross-sectional shapes. In either case, the slots (5) may be formed into some, or all, of the hollow cores/tubes (2) for balancing air/gas flow. The slotting of the hollow core slab (1) may be made during the initial manufacturing of the hollow core slab (1), or may be added afterwards using a concrete saw or other suitable device. The pretensioned steel cables (3) can be installed by the hollow core slab manufacturer prior to casting and can have a varied preloading tension as needed.

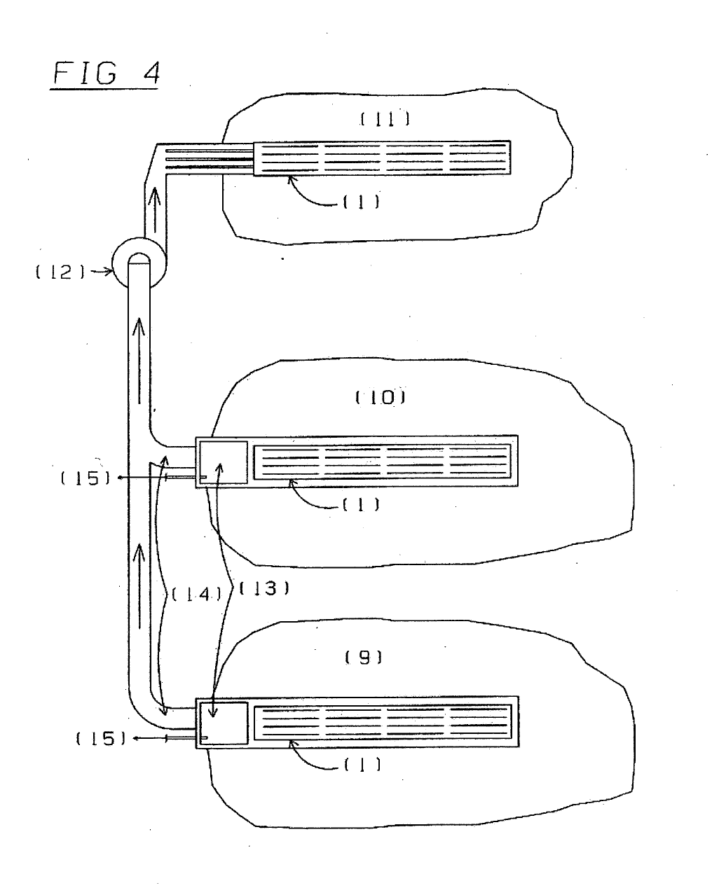

The hollow core/tubes (2) facilitate the flow of air/gases into and/or from (positive or negative aeration) a plenum/collector sump (FIG. 4 (13)) located at one end of the hollow core slab. The slots (5) define a nozzle or opening for air/gases or liquids to flow in and/or out of the hollow core/tube(2). The width of the slot (5) can vary, but in one embodiment the width is approximately 0.125 inch to 1 inch wide at the top. In FIG. 3B, it shows a removable end cap (8) that can be placed at the end of the hollow core/tubes (2) to prevent flow into the core/tubes other than through the slots (5).

FIG. 4 shows a layout of a negative aeration composting system, including a composting floor (9), a curing floor (10), and a biofilter floor (11) in accordance with one embodiment of the invention. Each of the floors (9), (10), and (11) in the illustrated embodiment include non-continuous slots (7) in the slotted hollow core aeration floors. In one process, initial composting can be done on the composting floor (9), and then finished on the curing floor (10). The gases generated in the composting and curing floors (9 & 10) can be pulled through the slotted hollow core slabs (1) into the plenum/collector sump (13) and then discharged through the gas discharge pipe (14) to the fan (12), and finally sent to the biofilter floor (11) for deodorizing and treatment. The liquid leachate discharge pipe (15) leads from the collector sump (13) to a recycling and cleaning facility (not shown).

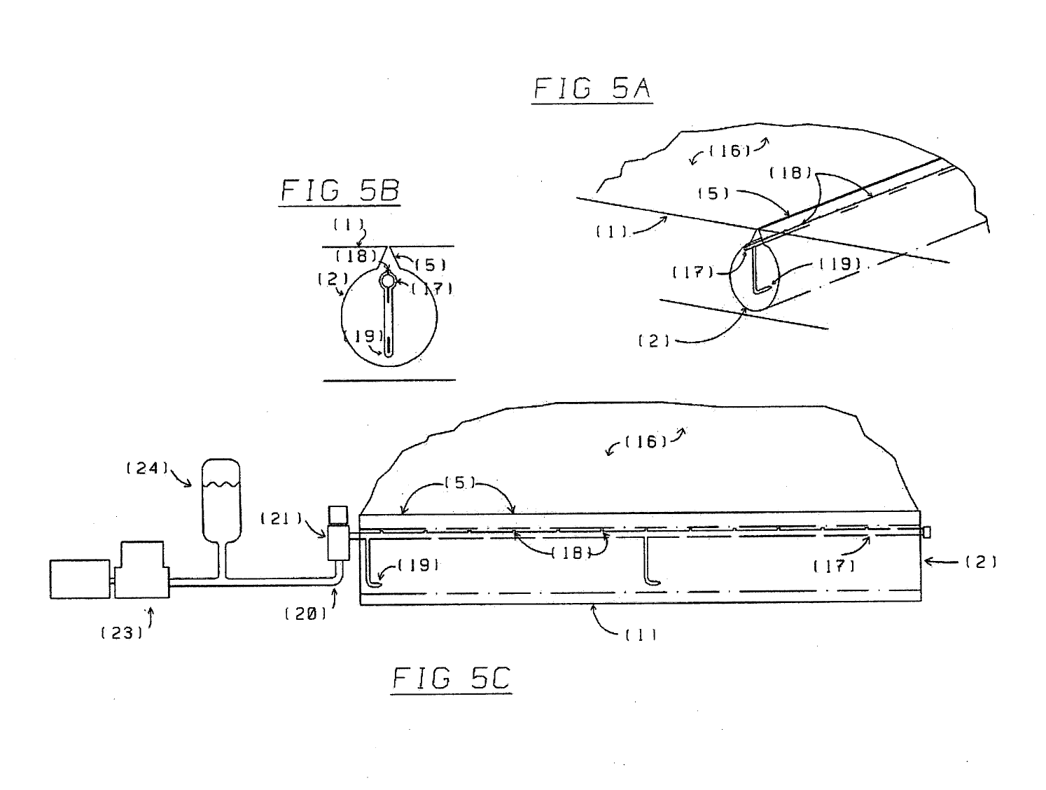

FIGS. 5A, 5B, and 5C show partial views of perspective, end, and side elevation of a composting slotted hollow core slab (1) with the addition of a high pressure water pipe (17) in accordance with another embodiment of the invention. The water pipe (17) can be located in or under the slot (5) and may contain vertical (up facing) nozzles (18) and longitudinal (facing) nozzles (19) supplied by a high pressure (e.g., greater than 1,000 psi) water supply (20) and controlled by a high pressure solenoid valve (21). This system may be operated periodically for cleaning of the slots (5) and the hollow core/tube (2). For composting applications, the vertical nozzles (18) may also be modified to bore vertical aeration holes into the compost pile (16) above to aid in airflow and to agitate the pile causing rechanneling of the air flow. The vertical nozzles (18) may be merely calibrated holes drilled into the water pipe (17), or separately attached precision calibrated nozzles. The nozzles may have a small diameter (e.g., less than 0.125 inches). FIG. 5C shows a low volume, high pressure water pump (23) supplying high pressure water to the high pressure solenoid (21). An air/water accumulator (24) is connected to the high pressure water supply pipe (20) to maintain water pressure when the pump is overwhelmed by the high flow rate when the solenoid is opened.

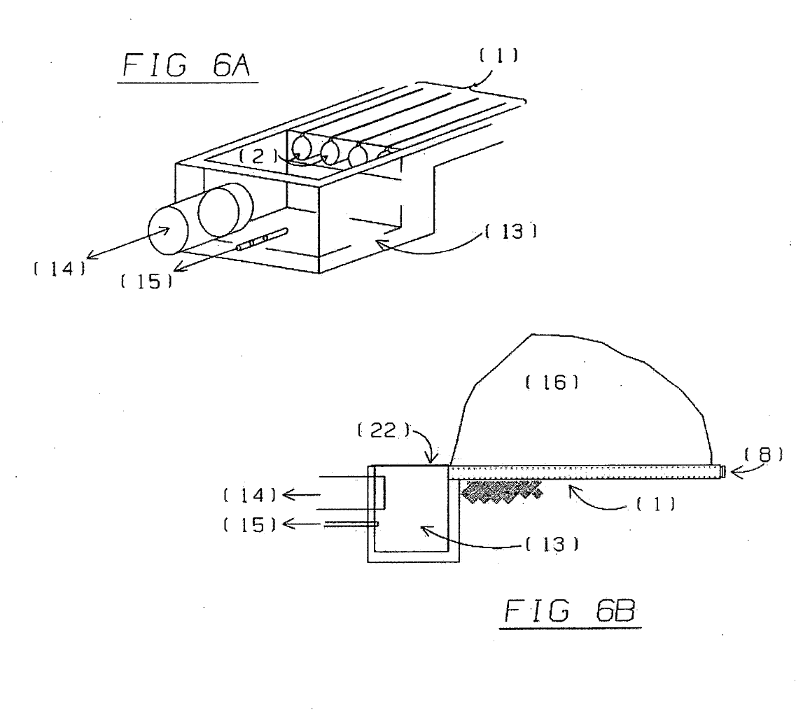

FIG. 6A and FIG. 6B shows a perspective view and a side elevation view of a slotted hollow core aeration floor panel (1) connected to the plenum/collector sump (13) in accordance with one embodiment of the invention. Both gases and liquid leachate can flow into the plenum/ collector sump (13) from the hollow core/tube (2). The plenum/collector sump (13) may be covered at the top with a removable plate (22) which seals the sump and allows access for cleaning. The liquid leachate pipe (15) can be positioned above the floor of the collector sump (13), but below the gas discharge pipe to prevent liquid from entering the gas discharge pipe (14).

In one application, to make a slotted hollow core slab aeration floor wider, it can be constructed by placing the slotted hollow core slabs (1) adjacent (side by side) to each other longitudinally and horizontally, and then grouting between the manufactured locking notches (4) in the sides of the slabs. To make the aeration floor longer, the hollow core/tubes (2) can be fitted end-to-end with other hollow core slabs (1) using an insert (not shown) to align the hollow core/tubes (2).

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the disclosure uses the word “or” in reference to a list of two or more items, that word covers all of the following interpretations of the word: any of the items in the list, all of the items in the list and any combination of the items in the list.

The detailed descriptions of embodiments of the invention are not intended to be exhaustive or to limit the invention to the precise form disclosed above. While specific embodiments of, and examples for, the invention are described for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not necessarily the system described herein. These and other changes can be made to the invention in light of the detailed description.

I claim:

1. An aeration floor system, comprising:
a hollow core member including a surface and a hollow tube extending in a direction generally parallel to the surface; and
a slot extending between the surface and the hollow tube, the slot having a generally tapered cross-sectional shape.

2. The aeration floor system of claim 1 wherein the slot has an inverted “V” cross-sectional shape.

3. The aeration floor system of claim 1 wherein the slot has a first width at the hollow tube and a second, smaller width at the surface.

4. The aeration floor system of claim 1 wherein the slot is a continuous slot.

5. The aeration floor system of claim 1 wherein the slot is a discontinuous slot with a plurality of discrete sections spaced apart from each other.

6. The aeration floor system of claim 1 wherein the hollow core member comprises a concrete slab with pretensioned steel cables embedded at least partially within the concrete slab.

7. The aeration floor system of claim 1, further comprising:
a conduit positioned in at least one of the hollow tube or the slot, the conduit including a plurality of nozzles positioned to direct a flow out of the slot; and
a pump operably coupled to the conduit for driving a liquid through the nozzles.

8. The aeration floor system of claim 1 wherein:
the hollow tube is a first hollow tube;
the slot is a first slot;
the hollow core member further includes a second hollow tube spaced apart from the first hollow tube; and
the aeration floor system further comprises a second slot extending between the surface and the second tube.

9. The aeration floor system of claim 1, further comprising:
a conduit positioned in at least one of the hollow tube or the slot, the conduit including a plurality of nozzles positioned to flow a liquid in a direction generally parellel to the tube; and
a pump operably coupled to the conduit for driving a liquid through the nozzles.

10. The aeration floor system of claim 1, further comprising:
a fluid conduit positioned in at least one of the hollow tube or the slot;
an accumulator in fluid communication with the fluid conduit; and
a pump operably coupled to the accumulator.

11. A method for processing organic material, the method comprising:
providing a precast hollow core member including a surface, a plurality of hollow tubes, and a plurality of tapered slots extending between the surface and corresponding tubes;
placing an organic material on the surface of the hollow core member; and
flowing a gas through the tapered slots.

12. The method of claim 11 wherein flowing the gas through the tapered slots comprises flowing the gas from the slots to the hollow tubes.

13. The method of claim 11, further comprising flowing a liquid from the organic material through at least one of the slots and the corresponding tube and into a collection sump.

14. The method of claim 11, further comprising flowing a liquid from a plurality of nozzles positioned at the slots to remove organic material from the slots.

15. The method of claim 11, further comprising flowing a liquid from a plurality of nozzles positioned at the tubes to clean the tubes.

16. The method of claim 11 wherein providing the precast hollow core member comprises providing a precast hollow core concrete slab having a plurality of tapered slots with an inverted “V” cross-sectional shape.

17. The method of claim 11 wherein placing the organic material on the surface of the hollow core member comprises positioning the organic material on the hollow core member for composting.

18. The method of claim 11 wherein placing the organic material on the surface of the hollow core member comprises positioning a perishable agricultural product on the hollow core member.

19. The method of claim 11, further comprising flowing a liquid from a plurality of nozzles positioned in at least one of the slots or the tubes to form holes in the organic material.

20. The method of claim 11, further comprising flowing a liquid from a plurality of nozzles positioned in at least one of the slots or the tubes to reshape the organic material.

21. A method for cleaning an aeration floor, the method comprising:
providing a floor member having a surface, a hollow tube, and a slot extending between the surface and the tube;
placing an organic material on the surface of the floor member; and
spraying a liquid into the slot to remove organic material from the slot with a nozzle positioned in at least one of the tube or the slot.

22. The method of claim 21, further comprising flowing a gas through the slot.
